(19) United States
(12) Patent Application Publication
(10) Pub. No.: US 2009/0269446 A1
(43) Pub. Date: Oct. 29, 2009

(54) Fillings

(76) Inventors: Jean-Luc Rabault, Ponthevrard (FR); Francois Belouin, Cerny (FR)

Correspondence Address: FITCH EVEN TABIN & FLANNERY, 120 SOUTH LASALLE STREET, SUITE 1600, CHICAGO, IL, 60603-3406, US

(21) Appl. No.: 12/440,896

(22) PCT Filed: Sep. 6, 2007
(86) PCT No.: PCT/FR2007/051886

§ 371 Date: Mar. 11, 2009

(30) Foreign Application Priority Data
Sep. 11, 2006 (FR) 0607936

(51) Int. Cl. A21D 13/00; A23D 9/007

(52) U.S. Cl. 426/94; 426/601; 426/613

(57) ABSTRACT

The invention relates to a filling consisting of a continuous aqueous phase, wherein said filling has a water activity (Aw) of 0.5 to 0.93, and a fat content of less than 25% by weight relative to the total weight of the filling, and comprises at least one non-gelatinized starch, characterized in that at least 5%, preferably at least 10%, and even more preferably at least 15%, of the particles are greater than or equal to 10 μm in size.

This invention concerns a filling consisting of a continuous aqueous phase, said filling having a water activity (Aw) of 0.5 to 0.93, and a fat content less than 25% by weight in relation to the total weight of the composition, and containing at least one non-gelatinized starch, at least 5% of the particles of said non-gelatinized starch having a particle size greater than or equal to 10 μm.

The reduction of the fat, and sugar content in food products, while keeping their organoleptic properties, and texture, is a major challenge for the agroalimentary industry. In the domain of cookies, and cakes with continuous aqueous phase filling, the reduction in fat, and sugar content proves particularly difficult. Nonetheless, such reduction is very desirable to fight obesity.

Filled cookies, and cakes are generally much appreciated by consumers, but such products are often rich in calories, and nutritionally unbalanced, notably because of a too large proportion of calories from fat, and sugars.

In order to alleviate such inconveniences, various filled cookies, and cakes light in fat and/or sugar have been proposed. Such light products often have less of a satiating power than traditional filled cookies, and cakes, and therefore often result in an immediate or deferred hunger sensation. Therefore, the consumer often eats either a greater quantity of these light products in relation to the traditional corresponding products, or eat something else in addition to the light product. The effect of the light product lower caloric contribution is hence countered by the additional caloric supply.

Hence, the addition of proteins has been proposed. However, these confer a sticky texture to the product if they are used in high concentration and, moreover, they are expensive. Adding soluble, and insoluble fibers has also been proposed. However, these solutions present numerous inconveniences. It is true that soluble fibers increase repletion, but their use is often linked to digestive disorders as bloating, flatulences, or accelerated transit. In general, insoluble fibers cause intestine irritations, and are not always organoleptically acceptable. Polyols are often used to replace all or part of the sugars in sugar flavor products. But their use also presents many inconveniences, such as their high price, the fact that their use is not recommended for children, and the same digestive disorders as soluble fibers as well as a bad image among consumers.

It is known to add gelatinized starch, either as a pre-gelatinized starch or, most often, by cooking a native starch during the manufacturing process, notably during pasteurization or sterilization, as a thickener (texture agent) in fillings.

Moreover, said gelatinized native starch undergoes retrogression over time, especially for very low humidity products, which results in a texture modification, namely syneresis. In order to avoid such phenomenon, starch is sometimes modified chemically or physically.

However, the modification strongly reduces the interest of such starch for the consumer, because it is perceived as an additive rather than a natural ingredient.

In addition, cooking, under the effect of hydration, and heat, has for effect to increase the food glycemic index. Carrots, for example, have a glycemic index of 35 when raw. As soon as they are boiled in water their glycemic index increases to 85 because of its starch gelatinization. A food rich in nutrients with high glycemic index is particularly not in line with nutritionists' recommendations for food with low glycemic index.

One goal of this invention is therefore to palliate to all or part of the above stated inconveniences, and notably to propose filings more in line with nutritionists' recommendations to reduce calories originating from fat or sugars, and to increase the caloric part coming from complex carbohydrates.

Another goal is to propose fillings with a higher and/or more prolonged satiating power than fillings of the anterior art.

To this end, this invention proposes a filling consisting of a continuous aqueous phase with a water activity (Aw) of 0.5 to 0.93, and a fat content of less than 25% by weight in relation to the filling total weight, and that contain at least one non-gelatinized starch, at least 5% of the particles of aforesaid non-gelatinized starch having a particle size greater than or equal to 10 μm.

The man of the art knows different techniques for recognizing non-gelatinized starch; the simplest being the observation under a polarized light microscope: non-gelatinized grains appear shaped as a “Maltese cross” (birefringence), whereas gelatinized grains lose this characteristic.

The filling according to the invention can be a sugar flavor filling, such as a chocolate, vanilla, milk, caramel, coffee, hazelnut, mint, or a fruit flavor filling, or a salt flavor filling, i.e. cheese, meat, fish, spices, vegetables.

The water activity (Aw) of a material is defined as the ratio between the material water vapor pressure, and pure water vapor pressure at the same temperature. This notion is well known of the skilled man who perfectly knows the appropriate measuring methods. In most cases, water activity is not proportional to the water content of the material. Thus, water activity (Aw) of a fruit yogurt with 82% water content by weight is for example 0.99, while butter, which also has a 0.99 water activity, has 16% water content by weight. As a convention, we measure all Aw in this invention at 25° C., and 24 hours to 3 days after manufacturing the recipes.

The water activity of the filling according to the invention is generally from 0.5 to 0.93. In a form of embodiment, Aw of the filling according to the invention is advantageously from 0.5 to 0.8, preferably from 0.65 to 0.75, and even more preferentially from 0.68 to 0.72. Such fillings according to the invention are suitable, in their package, for storage at a temperature ranging between 15, and 25° C. for at least one week, preferably for at least one month.

In another form of embodiment, Aw of the filling according to the invention is advantageously from 0.80 to 0.93, preferably from 0.85 to 0.92, and even more preferentially from 0.87 to 0.90. Such fillings according to the invention are suitable, in their package, for refrigerated storage at a temperature ranging from 1 to 10° C. for at least one week, preferably for at least 1 month, or for a frozen storage for at least 1 month, preferably for at least 6 months.

Advantageously, dry matter content of milk product fillings according to the invention is less than 80%, preferably less than 70%, and even more preferentially less than 60% by weight.

The applicant has had the merit to find that it was possible to improve the nutritional composition, and to increase the satiating power of fillings consisting of a continuous aqueous phase, and to improve their nutritional composition in accordance with nutritionists' recommendation, by adding at least one non-gelatinized starch. In fact, by adding a non-gelatinized starch, the ratio (calories brought by slowly digestible carbohydrates)/(total calorie content) is increased, which delays the occurrence of hunger sensation after consuming a filling according to the invention.

The addition of a non-gelatinized starch not only enables to increase the (calories brought by slowly digestible carbohydrates)/(total calorie content) ratio, but also to reduce the fillings' sugar and/or fat content. According to this invention, it is thus possible to provide fillings light in sugars, notably in sucrose, that possesses a higher and/or more prolonged satiating power than a traditional filling, namely light.

According to this invention, it is thus possible to provide fillings consisting of a continuous aqueous phase light in fat and/or in sugars, that possess a higher and/or more prolonged satiating power than a traditional light continuous aqueous phase filling.

The fillings according to the invention have a fat content of less than 25% by weight in relation to the total weight of the filling. Preferably, the fat content is from 0 to 25%, preferably from 0 to 21%, and advantageously from 0 to 15, and preferably from 5 to 15% by weight in relation to the total weight of the filling.

Contrary to sugars, non-gelatinized starch is not sweet and not water soluble, and it is therefore surprising that fillings according to the invention present similar, or even better, organoleptic characteristics than conventional very sweet products, often perceived as burning the mouth or the back throat.

According to the invention, any type of starch can be used in the filling provided said starch is non-gelatinized. The term “non-gelatinized starch” means that the starch is neither pre-gelatinized, nor gelatinized during the process of manufacture or of preparation before consumption. Of course, one may use mixtures of starches of different origins.

The starches to be used for the purposes of this invention include wheat starch, rice starch, corn starch, waxy corn starch, sorghum starch, tapioca starch, potato starch, cassava starch, and their mixtures.

According to the invention, at least 5%, preferably at least 10%, and even more preferentially at least 15% of the non-gelatinized starch particles have a size greater than or equal to 10 μm. In this way, a good compromise is reached between the viscosity increase of the filling after adding non-gelatinized starch, and the increase of the (calories brought by carbohydrate complexes)/(total calories) ratio.

In an advantageous mode embodiment, at least 90% of non-gelatinized starch particles ranges between 2 μm and 100 μm in size, preferably between 5 μm and 45 μm.

Advantageously, the non-gelatinized starch is a native starch. Contrary to gelatinized starches, and to most other hydrocolloids, including proteins and maltodextrines, native starch presents in general a low water absorption. Therefore, adding native starch to a filling consisting of a continuous aqueous phase only results in a light increase in viscosity, while aforementioned gelatinized starch or other hydrocolloids will cause an important increase in viscosity. The use of native starch thus enables to add larger quantities of starch in relation to the gelatinized starch, while keeping viscosity close to that of the starting product.

Moreover, native starch being a non-modified natural product, it is not part of the food additives, which should be labeled as such on the package of the marketed product.

In addition, native starch does not present any digestive inconveniences, contrary to polyols, and soluble fibers that have, among others, a laxative effect, which is particularly undesirable in products intended for children. The fact that it is not gelatinized keeps native starch slowly digestible, which enables to increase the (calories brought by slowly digestible carbohydrates)/(total calorie content) ratio. Therefore, the addition of native starch to fillings according to the invention entails a prolonged satiation feeling in relation to fillings consisting of a traditional continuous aqueous phase, notably in relation to food compositions consisting of a continuous aqueous phase light in sugars and/or fat. And in particular, the calorie distribution is more balanced between complex carbohydrates, fat, and sugars, in accordance with nutritionists' recommendations.

In addition, native starch density is high, which limits steric congestion, and its granules present little porosity accessible to water constituting the continuous aqueous phase. Both characteristics are important in order to limit the increase in viscosity of a filling containing solids in suspension, such as starch granules.

The particle-size distribution of native starches, which generally ranges between 2 μm and 100 μm, and generally between 5 μm and 45 μm, is also ideal for a use in fillings consisting of a continuous aqueous phase. Thus, native starches include neither too many fine particles, nor too many large particles. The presence of fine particles increases the viscosity of the filling, and therefore requires in general an increase in fat and/or water content. To the contrary, the presence of large particles confers to the filling a sandy sensation in the mouth. The balance between small, and large size granules may be adjusted as needed according to sought-after textures and properties, by mixing starches of various origins in various proportions.

Among native starches, wheat starch is preferred because it presents an ideal particle-size distribution from 2 μm to 45 μm, and because it is cheap.

Corn and cassava starches are also among the preferred starches for their particle-size distribution.

Other advantages of native starch are its neutral taste, and its white color, which enables its use in a broad range of products, namely products that are little aromatic, such as vanilla flavor fillings. Finally, native starch is a cheap ingredient and it can be used without grinding in fillings consisting of a continuous aqueous phase, which enables a simplified manufacturing process and a greater productivity.

However, it is also possible to use ground starch in order to obtain specific particle-size distributions that are not, or hardly, accessible without grinding.

In addition to native starch, one can also use overdry starches according to the invention, e.g. non-gelatinized starches with a humidity content brought below their relative humidity at equilibrium. One may also consider using a mixture of native, and overdry starches, or different types of overdry starches.

A non-gelatinized starch is generally contributed under form of a starch powder, but can also be contributed in all or in part as flour rich in non-gelatinized starch, or as a flour mixture rich in starch. Using a starch powder is preferred, even if in some cases using a flour rich in starch can be advantageous, notably in terms of cost.

A starch powder is preferred namely because it modifies less the characteristics of the product in which it is incorporated than flour. Thus, starch powder makes the product that contains it less sticky than flour from the absence of proteins. In addition, starch powder presents a finer particle-size distribution than flour because it mainly contains isolated starch grains, and no grinded cells as flour. Finally, starch powder has a more neutral taste, and a whiter color than flour.

A flour rich in starch can be a native or overdry flour. One can use cereal flours for example, such as wheat flour, corn flour, or rice flour, or tuber flours, such as potato flour. As an example, one can mention wheat flour, which can be assimilated to a mixture of 12% by weight of proteins, 83% of starch with 13% of water, 1% of fat, and 4% of fibers.

In one form of embodiment, the starch content of the filling according to the invention is from 2 to 40%, preferably from 4 to 40%, and even more preferentially from 4 to 26, 7 to 22, 10 to 22, and 13 to 18% by dry weight in relation to the filling weight. Wheat starch generally contains 13% of water, and 87% of dry starch. Using 40% of wheat starch therefore contributes 34.8% of dry starch.

As starch grains are forming a suspension in the aqueous phase of the filling, the skilled man will therefore preferably choose a low flow threshold for the filling according to the invention in order to avoid or to limit starch grain sedimentation. However, in some cases, starch grains sedimentation may be acceptable.

The filling according to the invention can be a sweet or salty taste composition.

Fillings according to the invention have a sugar content from 0 to 70%, preferably from 0 to 50%, and even more preferentially from 10 to 40, 10 to 30, 10 to 25, and advantageously from 10 to 20% by weight in relation to the total weight of the filling. In case of salty taste fillings according to the invention, the sugar content is generally from 0% to 55%, preferably from 0 to 35%, and even more preferentially from 0 to 25%, and even from 5 to 25%, and more particularly from 5 to 15% by weight in relation to the total weight of the filling. Sweet taste fillings according to the invention have from 0 to 70%, preferably 0 to 50%, and even more preferentially 10 to 40, 10 to 30, 15 to 25, and advantageously 15 to 20% by weight in relation to the total weight of the filling.

In the meaning of this application, the term “sugars”, plural, designate mono-, and di-saccharides contributed on their own or through ingredients containing them.

In an advantageous form of embodiment, fillings according to the invention have a sucrose content from 0 to 30%, preferably from 0 to 20%, and even more preferentially from 0 to 15, and advantageously from 5 to 10% by weight in relation to the total weight of the filling.

One may also consider fillings according to the invention that contain no sucrose at all, a sweet flavor capable to be brought in by fructose and/or sweeteners such as polyols, intense sugar substitutes (e.g. aspartame or acésulfameK) or their mixture.

The fillings according to the invention may include in addition, among others, emulsifiers, salt, aromas, preservatives, cocoa under different forms (preferably as degreased or greatly degreased cocoa powder), fruits, whole or in chunks, fruit or vegetable mash, in chunk or in powder, fruit slurry, jams, hazelnuts, or other ground dry fruits, cereals, spices, herbs, soluble or insoluble fibers, yeasts, or their extracts.

Emulsifiers are those usually used in the domain of fillings, namely lecithin, ammonium phosphatide, polyglycerol polyricinoleate (PGPR), mono- and di-glycerides, or their mixtures.

Aromas may be natural or synthetic. Among natural aromas one can mention vanilla, caramel, cinnamon, and among synthetic aromas: vanillin and some fruit imitation aromas, such as strawberry or raspberry.

Native starch brings in a certain level of microorganisms, which can damage the quality of the filling, in general namely its stability. Such risk of degradation is namely weak in fillings with a water activity (Aw) from 0.6 to 0.73, more strongly for Aw from 0.74 to 0.89, and very strongly for Aw from 0.90 to 0.99. Such risk, well known of the man of the art, depends also of the pH, the temperature, and the duration of conservation. In order to avoid such phenomenon, the product can be refrigerated and/or, according to its life span, one can either pasteurize or sterilize (i.e. by irradiation) the native starch before incorporating it in the filling, or add a preservative to the filling. By “preservatives”, one means compounds inhibiting or delaying the proliferation of microorganisms in the composition, in particular yeasts and/or mildews, and/or bacteria. Preservatives to be added to fillings according to the invention are those usually used in the domain of fillings, and include notably sorbic acid and its salts (E200 in E203), benzoic acid and its salts (E210 in E219), sulfites and derivatives (E220 in E228), natamycin, nisin, calcium propionate, and their mixtures.

Preferably, one will use a preservative if Aw is greater than 0.72, and especially greater than 0.80. An example of a preferred preservative is potassium sorbate.

Fillings according to the invention can be obtained according to classic manufacturing processes for these types of products, which are well known of the skilled man. Fillings can be slightly aerated during manufacture, namely in order to obtain a density of 650 g/l to 1100 g/l, preferably of 750 g/l to 1000 g/l. A non aerated filling generally has a density of about 1100 to 1300 g/l.

Starch gelatinization is a phenomenon well known of the man of the art. It is characterized by an important swelling of the starch granules through water absorption, even up to bursting if heating is too intense. The immediately visible consequences are an increased viscosity and starch “solubilization” in the aqueous medium, while some non-gelatinized granules are only dispersed in suspension. Gelatinized starch “solubilization” results in the disappearance of the turbidity associated with the dispersion of non-gelatinized starch granules.

Gelatinization occurs in the presence of water above a certain temperature. It is a fast and straightforward phenomenon, i.e. almost all the granules of a same native starch in the same medium jellify at a temperature T +/−° C. Such gelatinization is irreversible.

But the gelatinization temperature of native starch varies according to the nature of the starch, and the composition of the aqueous food medium. Thus, the gelatinization temperature for cassava starch in pure water occurs at 70° C., whatever e.g. the date of harvest, for potato starch it occurs at 63° C., for corn starch at 76° C., for wheat starch at 82° C. (measuring method: gelatinization temperature of a 8% starch suspension in water placed in a Brabender viscoamylograph; heating through double envelope at 1.5° C./minute). With regard to the influence of the gelatinization medium composition, increasing sugar content as well as reducing water raise the gelatinization temperature.

Thus, in the context of this invention, the gelatinization temperature to take into consideration corresponds to the gelatinization temperature of native starch used in the aqueous food medium, and not in pure water.

Thus, in order to preserve the starch in its native state in the filling according to the invention, it is imperative not to heat it over its gelatinization temperature during the filling preparation and/or during ulterior use. Preferably, during its preparation, and/or subsequently, the filling according to the invention is heated to a maximum temperature which is 7° C. less than the gelatinization temperature of the starch used. In case a mixture of various starches is used, the lowest gelatinization temperature is determining.

For example, in case of using a filling according to the invention to fill a soft cake, the filling is preferably introduces after cooking the cake while the cake is still hot. The filling temperature is chosen so that it is not greater than the gelatinization temperature of the native starch.

The fillings according to the invention are particularly useful as fillings for cooked cereal products or fillings for bars or fresh bites. The term “cooked cereal products” as used in this application includes dry cookies, wafers, toasts, cereal bars, soft cakes, doughnuts, cream puff pastries.

The term “bars or fresh bites” designates a shell of chocolate or black, milk, white, or flavored (i.e. with dried fruits, red fruits, coffee) imitation chocolate filled with a filling.

One object of this invention is therefore a bar or fresh bite containing a filling according to the invention at 0.78 to 0.93 Aw. Preferably this bar or fresh bite is conserved, in its package, for at least 2 weeks at a temperature between 1 and 10° C.

Another object of this invention is a cooked cereal product containing a filling according to the invention.

The cooked cereal product according to the invention can be i.e. a dry cookie comprising at least one layer of filling according to the invention between two layers of dry cookie.

It can also be a filled wafer, in which at least two parts, preferably two layers of wafer are separated by a layer of filling according to the invention. Preferably, the filled wafer includes 2 to 4 layers of wafers separated from one another by one layer of filling according to the invention.

The cooked cereal product according to the invention can also consist of a filling according to the invention dropped in a hollow biscuit, i.e. a tart or a barquette.

Preferably, the cooked cereal product according to the invention is a soft cake. The soft cake may include for example a core of filling according to the invention, which can be introduced, for example, by injection. The soft cake can also be a rolled cake obtained by spreading the filling according to the invention on at least one of the surfaces of the soft cake, and then rolling it. The soft cake can also include at least one layer of filling according to the invention between at least two layers of soft cake. The soft cake can also include at least one layer of filing according to the invention between a layer of soft cake, and a chocolate or imitation chocolate shell.

Generally, the cooked cereal product according to the invention contains from 16% to 55%, advantageously from 20% to 45%, preferably from 25% to 35%, and even more preferentially from 25% to 30% for an additional nutritional advantage, or else from 28 to 35% for an additional organoleptic advantage, by weight of filling according to the invention in relation to the total weight of the finished product.

The cooked cereal product according to the invention advantageously contains from 1.5% to 25% by weight of fat in relation to the total weight of the cooked cereal product, preferably from 2 to 20%, even more preferably from 2 to 15%, and even from 5 to 12%.

The cooked cereal product according to the invention advantageously contains from 20% to 63% by weight of sugars in relation to the total weight of the cooked cereal product, preferably from 27 to 58%, even more preferably from 27 to 48%, and even from 35 to 46%. Even more preferentially, it includes from 18% to 48% by weight of sugars in relation to the total weight of the cereal cooking product, preferably from 18 to 38%, even more preferably from 18 to 28%, and even from 20 to 25%.

After sealed packaging, the cooked cereal products according to the invention are conserved at a temperature ranging between 15 and 25° C. for at least one week, preferably for at least one month, if the filling Aw is from 0.5 to 0.8, preferably from 0.65 to 0.75, and even more preferentially from 0.68 to 0.72. If the filling Aw is from 0.80 to 0.93, preferably from 0.85 to 0.92, and even more preferentially from 0.87 to 0.90, the cooked cereal products according to the invention are conserved after sealed packaging at a temperature ranging between 1 and 10° C. for at least 1 week, preferably for at least 1 month, or stored frozen for at least 1 month, preferably for at least 6 months.

The following examples of embodiment illustrate this invention, without limiting in any way its scope.

### EXAMPLE 1

### Chocolate Taste Filling

One prepares 2 chocolate flavor fillings consisting of a continuous aqueous phase, including a control filling corresponding to a classic filling without starch, and a filling according to the invention. The respective compositions of said fillings are indicated hereafter in Table 1.

The fillings are prepared in the following way. All ingredients are weighed as powders, and then mixed. Chocolate is melted at 40° C., and added with colza oil, lecithin, as well as PGPR, as needed. The chocolate preparation is then mixed until total homogenization. Then water-soluble fluids are homogenized with a Rayneri V.M.I Trimix TXR50 mixer, and the ingredients that are under form of powders are poured on the mixture while stirring (stirring speed: 1000 to 3000 rpm), and stirring is kept for another 5 minutes. Then the homogenized and 40° C. warm chocolate preparation is incorporated under stirring into the hydrosoluble fluid/powder mixture until obtaining a perfect homogenization. The properties of the fillings so obtained are indicated hereafter in Table 2.

TABLE 1

| | | Filling according |
|---|---|---|
| | Control filling | to the invention |
| Composition | (% by weight) | (% by weight) |
| Sucrose under form of icing | 10.9 | — |
| sugar | | |
| Glucose syrup 71 DE (39% | 32.0 | — |
| mono, and disaccharides) | | |
| Monohydrated dextrose | — | 9.9 |
| Fructose | — | 9.0 |
| Colza oil | 11.7 | 10 |
| Lecithin | — | 0.5 |
| Dark chocolate (52.65% cocoa | 20 | 20 |
| paste, 39.95% sucrose, 4% | | |
| cocoa powder, 3% cocoa butter, | | |
| lecithin, vanillin) | | |
| Native wheat starch at 13% | — | 18.4 |
| water | | |
| Maltodextrin 15DE | — | — |
| Glycerol | 2.5 | 5.0 |
| Skim milk powder | 7.4 | 7.4 |
| Whole milk powder | 5.7 | 5.7 |
| PGPR | — | 0.1 |
| Water | 9.8 | 14.0 |
| Total | 100 | 100 |

TABLE 2

| | | Filling according |
|---|---|---|
| | Control filling | to the invention |
| % fat by weight | 19.83 | 18.73 |
| % sugar by weight | 37.45 | 32.07 |
| % water by weight | 16.45 | 18.00 |
| % native dry starch by weight | 0.98 | 16.98 |
| Water activity (Aw) | 0.72 +/− 0.02 | 0.73 +/− 0.02 |
| Total Kcal/100 g | 415 | 400 |
| (kcal complex carbohydrates)/ | 1 | 17 |
| (total kcal) (%) | | |

Sugar content as well as fat content of the filling according to the invention are appreciably reduced in relation to the control filling.

In spite of sugar and fat reduction, the filling according to the invention presents a slightly lower sweet flavor, but quite close to that of the control filling. Moreover, the chocolate flavored taste remains very close to the standard, as well as the texture in mouth (hardness, sugar bonbon, particle-size distribution, pasty).

In addition, the filling according to the invention presents a (calories brought by slowly digestible carbohydrates)/(total calories) ratio that increases from 1% to 17% thanks to the addition of native starch in the filling according to the invention.

### EXAMPLE 2

### Soft Cakes Filled With Chocolate Flavor

21 g soft cakes were cooked according to a standard process. Such soft cakes, known to the man of the art, consist, by weight, of 13% fat, 61.8% carbohydrates of which 22.4% sugar (mono-, and disaccharides, including 17% sucrose), 6.3% proteins and 16.5% water.

With such soft cakes, 2 lots of filled soft cakes are prepared, corresponding to classic chocolate flavor filled soft cakes, including a batch of control soft cakes containing the control filling from Example 1, and a batch of soft cake according to the invention containing the filling according to the invention in Example 1.

Immediately after cooking them, the soft cakes are filled with 9 g of the respective fillings (or 30% filling and 70% soft cake) using a two needle injection system. The filling is injected at a temperature from 28 to 35° C. The cakes so filled are cooled down to 20° C.

The soft cakes filled according to the invention have an aspect strictly identical to the control, the taste of cake, and its soft texture being unaltered. The cakes according to the invention are perceived as very close of the control in terms of odor, sweetness, filling texture. The sugar bonbon, particle-size distribution, and pastyness are very close, and were not perceived as significantly different by a panel of consumers.

After sealed packaging, the soft cakes filled according to the invention keep for at least 4 month at 22° C.

1. A filling comprising of a continuous aqueous phase, said filling having a water activity (Aw) of 0.5 to 0.93, and a fat content of less than 25% by weight in relation to a total weight of the filling, and containing at least one non-gelatinized starch, wherein the non-gelatinized starch includes starch particles and at least 5% of the particles have a size greater than or equal to 10 μm.

2. The filling according to claim 1, wherein the starch is a native starch.

3. The filling according to claim 1 wherein the starch content is from 2 to 40% by dry weight in relation to the total weight of the filling.

4. The filling according to claim 1, wherein at least 90% of the starch particles have a particle-size distribution ranging between 2 μm and 100 μm.

5. The filling according to claim 1, wherein the starch is selected from the group consisting of wheat starch, rice starch, corn starch, waxy corn starch, sorghum starch, tapioca starch, potato starch, cassava starch, and their mixtures.

6. The filling according to claim 1, wherein the Aw is from 0.5 to 0.8.

7. The filling according to claim 6, wherein the Aw is from 0.80 to 0.93.

8. The filling according to claim 1, wherein dry matter is less than 80% by weight.

9. The filling according to claim 1, wherein the fat content is from 0 to 25% by weight in relation to the total weight of the filling.

10. The filling according to claim 1, wherein the filling has a sugar content from 0 to 70% by weight in relation to the total weight of the filling.

11. The filling according to claim 1, wherein the filling includes saccharose and the saccharose content is from 0 to 30% by weight in relation to the total weight of the filling.

12. A cooked cereal product comprising a filling, according to claim 1.

13. The cooked cereal product according to claim 12, wherein the cooked cereal product comprises a dry biscuit including at least one layer of said filling between two layers of dry biscuit or wafer.

14. The cooked cereal product according to claim 12, wherein the filling is dropped in a hollow biscuit, or between a layer of soft cake, and a chocolate or imitation chocolate shell.

15. The cooked cereal product according to claim 12, wherein the cooked cereal product is a soft cake.

16. The cooked cereal product according to claim 15, wherein the cooked cereal product includes a soft cake comprising a filling core.

17. The cooked cereal product according to claim 15, wherein the cooked cereal product includes a rolled soft cake obtained by spreading the filling over at least one of the surface of said soft cake and then rolling it.

18. The cooked cereal product according to claim 15, wherein the cooked cereal product includes a soft cake including at least one layer of said filling between at least two layers of soft cake.

19. The cooked cereal product according to claim 15, wherein the cooked cereal product includes a soft cake including at least one layer of said filling between one layer of soft cake, and a chocolate or imitation chocolate shell.

20. The cooked cereal product according to claim 12, wherein the cooked cereal product includes from 16% to 55% by weight of filling containing the food composition in relation to a total weight of a finished product.

21. The cooked cereal product according to claim 12, wherein the cooked cereal product includes from 1.5% to 25% by weight of fat in relation to the total weight of the cooked cereal product.

22. The cooked cereal product according to claim 12, wherein the cooked cereal product includes from 20% to 63% by weight of sugar in relation to the total weight of the cooked cereal product.

23. A bar or fresh bite comprising a filling according to claim 1, the filling having a 0.78 to 0.93 Aw.
